(19) United States
(12) Patent Application Publication
(10) Pub. No.: US 2025/0222371 A1
(43) Pub. Date: Jul. 10, 2025

(54) Dancing Puppet and Methods Therefor

(71) Applicant: CalCoast Toys LLC, Chatsworth, CA (US)

(72) Inventor: William Mark Forti, Claremont, CA (US)

(73) Assignee: CalCoast Toys LLC, Chatsworth, CA (US)

(21) Appl. No.: 19/011,355

(22) Filed: Jan. 6, 2025

Related U.S. Application Data
(60) Provisional application No. 63/618,686, filed on Jan. 8, 2024.

(51) Int. Cl. A63J 19/00; B33Y 80/00

(52) U.S. Cl. CPC A63J 19/006; B33Y 80/00

(57) ABSTRACT

An animation device for manipulating an object is provided. The animation device includes a base and a support member extending from the base. The animation device further includes a first arm moveably coupled to the support member and adapted to couple to a first part of the object. The animation device further includes a second arm moveably coupled to the support member and adapted to couple to a second part of the object. The animation device further includes a third arm fixedly coupled to the support member and adapted to couple to a third part of the object. The first and second arms are adapted to be operated by a user for manipulating the first and second parts of the object relative to the third part of the object.

This application claims priority to U.S. Provisional Patent Application No. 63/618,686, filed Jan. 8, 2024, which is incorporated by reference herein.

### Field of the Invention

The field of the invention relates to assemblies for puppets and, in particular, assemblies configured to manipulate puppets by a user.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Toy objects whose movement is generated by a thread of material that is in communication with the object are well known in the art. Typical toy objects include puppets whose movement is generated by a user pulling on, or otherwise manipulating, a number of strings which are attached to various parts of the object (e.g. a puppet). In order for a person to manipulate an object of this type to get the object to display fluid motion, the user must possess a relatively high degree of skill for the object to display a fluid motion. Furthermore, even with such high degree of skill, it is likely that an audience would be aware that there is someone operating the object's strings, thereby, watching without the illusion that the object is operating under its own power.

Further, other devices and systems for animating objects in the art, such as those disclosed in U.S. Pat. No 4,894,936A, introduce additional shortcomings. For example, U.S. Pat. No. 4,894,936A utilizes pre-programmed cam disk profiles supported by mechanisms involving cam disks, levers, Bowden cables, and sprocket wheels. Due to the pre-programming of movements, the range and type of movements of the object are limited to what has already been programmed. In addition, real-time adjustments of the object by the user are inherently complicated because any movements made by the user must be transmitted through the Bowden cables and lever mechanisms before causing movement in the puppet/object, making the object difficult to manipulate in real time. U.S. Pat. No. 4,894,936A is incorporated by reference herein.

Moreover, the “omnidirectional toy manipulator” disclosed in U.S. Patent Publication No. US20060160466A1 allows a user to vertically translate the toy figure relative to the toy device, but the toy figure is limited to this vertical movement. Further, U.S. Patent Publication No. US4179843A, which is hereby incorporated by reference herein, discloses a puppet controller having a frame for manual holding and manipulation, a first arm mounted on the frame, movable relative to the frame, and connectable to the puppet's feet, a second arm mounted on the frame, movable independently of the first arm, connectable to the puppet's hand, and a constraining means to selectively allow the first and second arms to move independently or simultaneously relative to the frame. The constraining mechanism in this reference is designed to either allow the two arms to move independently or to constrain them to move simultaneously. Using this design, the complexity of the object/puppet's animation is limited. For instance, many natural movements involve parts of the body moving relative to a fixed point or axis, so the lack of this capability would make the object/puppet's movements appear less realistic or lifelike.

Other devices for animating objects in the art, such as those disclosed in U.S. Pat. No. 4,901,459A, provide decorative action to dolls using a self-contained drive device that automatically generates animated motions of the doll's torso, head, and hands through internal activating mechanisms. Such devices do not allow a user to manually manipulate the individual portions of the object/doll, instead using motors, linkages, and slotted followers to provide automated animation rather than manual manipulation by a user. Therefore, the animation process is carried out by the device itself, with little to no direct user control. Thus, such devices fail to provide the level of control over the object/doll afforded by a manually controlled system. U.S. Pat. No. 4,901,459A is incorporated by reference herein.

Still further, the disclosure in U.S. Pat. No. 6,575,808B1, which is incorporated by reference herein, describes a puppet holding pom poms having a handle, head, and manipulable limb assemblies, where each limb assembly has an upper limb element and an extending limb element. This design allows a user to cause pivoting and extending of the limb assemblies, simulating cheering with pom poms, and swaying and moving of the pom poms attached to the limbs. There is also a description of a “resiliently connected” head, allowing some limited movement of the puppet's head. However, this design limits the object/puppet's motion to those associated with cheering. Additionally, as stated at the end of the Detailed Description of US575808B1, “The puppet 10 is held by a user's hand that grasps the handle 12. This same hand also operates the manipulable limb assemblies 20.” Handheld puppeteering devices suffer from challenges in maintaining the puppet's apparent independence from its user, especially because the user's hand is in constant, often visible contact with the puppeteering device, making it difficult to conceal the user's involvement.

In another device known in the art, disclosed in BE1016316A6 and incorporated by reference herein, two rocking arms, one at shoulder height and one at hip height, are connected by coupling rods. Therefore, when the user manipulates one rocking arm, the other rocking arm will move in a synchronized, flowing motion. Additionally, this device discloses a motor that may drive the rocking arm movement. Because the different parts of the puppet/object must move in a synchronized manner, the realism of the puppet's movement is severely limited.

Thus, even though various animation devices and methods of forming the same are known in the art, all or almost all of them suffer from several drawbacks. Therefore, there remains a need for improved animation devices and methods of forming the same.

### SUMMARY OF THE INVENTION

The inventive subject matter is directed to various animation devices and methods of forming the same.

In one aspect of the inventive subject matter, the inventors contemplate an animation device for manipulating an object. The animation device includes a base and a support member extending from the base. The animation device further includes a first arm moveably coupled to the support member and adapted to couple to a first part of the object. The animation device further includes a second arm moveably coupled to the support member and adapted to couple to a second part of the object. The animation device further includes a third arm fixedly coupled to the support member and adapted to couple to a third part of the object. The first and second arms are adapted to be operated by a user for manipulating the first and second parts of the object relative to the third part of the object.

It is contemplated that the animation device may further include a first lever moveably coupled to the base and adapted to couple to a fourth part of the object. The first lever may be adapted to be operated by the user for manipulating the fourth part of the object relative to the third part of the object. The first lever may be pivotably coupled to the base.

It is further contemplated that the animation device may further include a second lever moveably coupled to the base and adapted to couple to a fifth part of the object. The second lever is adapted to be operated by the user for manipulating the fifth part of the object relative to the third part of the object. The second lever may be pivotably coupled to base.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view illustrating an embodiment of an animation device for manipulating an object by a user. As depicted, three arms of the animation device are coupled to an object (a stuffed animal, a doll, a puppet, etc.), with the first and second arm being moveably coupled to the support member and the third being fixedly coupled to the support member.

FIG. 2 is another perspective view illustrating an embodiment of the animation device of FIG. 1.

FIG. 3 is another perspective view illustrating an embodiment of the animation device of FIG. 1.

FIG. 4 is another perspective view illustrating an embodiment of the animation device of FIG. 1.

FIG. 5 is another perspective view illustrating an embodiment of the animation device of FIG. 1.

FIG. 6 is an exemplary illustration of the animation device concealed behind a structure. The object is positioned in front of the structure.

### DETAILED DESCRIPTION

An animation device for manipulating an object is provided herein. The animation device may be utilized to manipulate any type of object 12. In certain embodiments, the object is selected from the group of a stuffed animal, a doll, a puppet, and combinations thereof. Manipulation of the object includes, but is not limited to, moving the object to dance, moving the object to perform an action (e.g. puppet show, ventriloquy, and the like), etc. The user may use any part of their body (e.g. fingers, arms, toes, feet, etc.), directly or indirectly, to operate the animation device for manipulating the object.

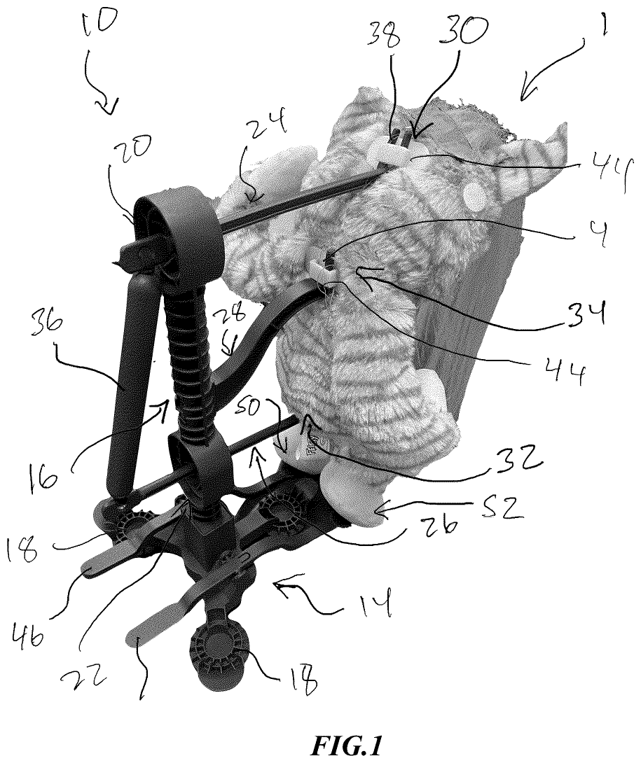

FIGS. 1-5 are perspective views illustrating an embodiment of the animation device 10 for manipulating the object 12 by a user. The animation device 10 includes a base 14 and a support member 16 extending from the base 14. In various embodiments, the base 14 is adapted for placement on a surface, such as a horizontal surface. In these and other embodiments, the base 14 includes a plurality of feet 18 adapted for placement on the surface. The plurality of feet 18 may include pads to decrease movement of the base 14 relative to the surface. However, it is to be appreciated that the base 14 may be adapted for placement on any surface (e.g. a vertical surface utilizing suction cups or magnets).

The support member 16 may extend transverse to the base 14. In certain embodiments, the support member 16 extends perpendicular to the base 14. However, it is to be appreciated that the support member 16 may extend at any angle relative to the base 14 depending on the orientation of the surface. In various embodiments, the support member 16 defines a first hole 20 and a second hole 22 spaced from the first hole 20. However, it is to be appreciated that the support member 16 may define any number of holes (e.g. one, three, four, five, six, seven, or eight, and even more). In these and other embodiments, the second hole 22 is adjacent to the base 14 and the first hole 20 is spaced from the base 14.

The animation device 10 further includes a first arm 24, a second arm 26, and a third arm 28. However, it is to be appreciated that the animation device 10 may include more arms (e.g. four, five, six, seven, or eight, and even more). The first, second, and third arms 24, 26, 28 may extend from the support member 16. However, it is to be appreciated that the one or more of the first, second, and third arms 24, 26, 28 may extend from any part of the animation device 10. In certain embodiments, the third arm 28 is disposed between the first arm 24 and the second arm 26 and the second arm 26 is adjacent to the base 14 and the first arm 24 is spaced from the base 14. However, it is to be appreciated that the first, second, and third arms 24, 26, 28 may be positioned in any order relative to each other and to any part of the animation device 10.

The first arm 24 is moveably coupled to the support member 16 and adapted to couple to a first part 30 of the object 12. The first arm 24 may engage the first hole 20 for moveably coupling the first arm 24 to the support member 16. In various embodiments, the first arm 24 extends through the first hole 20 for moveably coupling the first arm 24 to the support member 16. Operation of the first arm 24 by the user manipulates the first part 30 of the object 12. In exemplary embodiments, the first part 30 of the object 12 may be a head of the object 12 such that the first arm 24 is moveably coupled to the support member 16 and coupled to the head of the object 12. To this end, operation of the first arm 24 by the user manipulates the head of the object 12. However, it is to be appreciated that the first arm 24 may be coupled to any part of the object 12.

The second arm 26 is moveably coupled to the support member 16 and adapted to couple to a second part 32 of the object 12. The second arm 26 may engage the second hole 22 for moveably coupling the second arm 26 to the support member 16. In various embodiments, the second arm 26 extends through the second hole 22 for moveably coupling the second arm 26 to the support member 16. Operation of the second arm 26 by the user manipulates the second part 32 of the object 12. In exemplary embodiments, the second part 32 of the object 12 may be a lower torso of the object 12 such that the second arm 26 is moveably coupled to the support member 16 and coupled to the lower torso of the object 12. To this end, operation of the second arm 26 by the user manipulates the lower torso of the object 12. However, it is to be appreciated that the second arm 26 may be coupled to any part of the object 12.

The third arm 28 is fixedly coupled to the support member 14 and adapted to couple to a third part 34 of the object 12. In various embodiments, the third part 34 of the object 12 remains in position relative to movement of the first and second parts 30, 32. To this end, the first and second arms 24, 26 are adapted to be operated by the user for manipulating the first and second parts 30, 32 of the object 12 relative to the third part 34 of the object 12. In exemplary embodiments, the third part 34 of the object 12 may be an upper torso of the object 12 such that the third arm 28 is fixedly coupled to the support member 14 and coupled to the upper torso of the object 12. However, it is to be appreciated that the third arm 28 may be coupled to any part of the object 12.

It is contemplated that the animation device 10 may further include a linkage 36 coupled to both the first arm 24 and the second arm 26. In certain embodiments, the linkage 36 is moveably coupled to both the first arm 24 and the second arm 26. The user operates the first and second arms 24, 26 by maneuvering the linkage 36 with one hand of the user.

In various embodiments, the first arm 24 includes a first arm hook 38 adapted to couple to the first part 30 of the object 12, the second arm 26 includes a second arm hook 40 adapted to couple to the second part 32 of the object 12, and the third arm 28 includes a third arm hook 42 adapted to couple to the third part 34 of the object 12. The first, second, and third arm hooks 38, 40, 42 may cooperate with a plurality of anchors 44 that are coupled to the object 12 for coupling the first, second, and third arms 24, 26, 28 to the object 12. In various embodiments, the plurality of anchors 44 is coupled to the object 12 using a hook and loop fastener such as Velcro®. However, it is to be appreciated that any form of fastener may be utilized to couple the plurality of anchors 44 to the object 12 (e.g. adhesive, snaps, magnets, etc.).

The animation device 10 may further include a first lever 46 and a second lever 48. The first lever 46 may be moveably coupled to the base 14 and adapted to couple to a fourth part 50 of the object 12. The first lever 46 may be adapted to be operated by the user for manipulating the fourth part 50 of the object 12 relative to the third part 34 of the object 12. Likewise, the second lever 48 moveably coupled to the base 14 and adapted to couple to a fifth part 52 of the object 12. The second lever 48 may be adapted to be operated by the user for manipulating the fifth part 52 of the object 12 relative to the third part 34 of the object 12. In various embodiments, the first and second levers 46, 48 are pivotably coupled to base 14. However, it is to be appreciated that the first and second levers 46, 48 may be coupled to any part of the animation device 10.

In exemplary embodiments, the fourth part 50 of the object 12 may be a left foot of the object 12 such that the first lever 46 is pivotably coupled to the base 14 and coupled to the left foot of the object 12. To this end, operation of the first lever 46 by the user manipulates the left foot of the object 12. However, it is to be appreciated that the first lever 46 may be coupled to any part of the object 12.

Likewise, in exemplary embodiments, the fifth part 52 of the object 12 may be a right foot of the object 12 such that the second lever 48 is pivotably coupled to the base 14 and coupled to the right foot of the object 12. To this end, operation of the second lever 48 by the user manipulates the right foot of the object 12. However, it is to be appreciated that the second lever 48 may be coupled to any part of the object 12.

With particular reference to FIG. 1, the user maneuvers to linkage 36 to fully extend the first arm 24 though the first hole 20 and partially extend the second arm 26 through the second hole 22 to move the first part 30 (e.g. head) and the second part 32 (e.g. lower torso) of the object 12 relative to the third part 34 (e.g. upper torso) of the object 12 which is fixed in position relative to the support member 16.

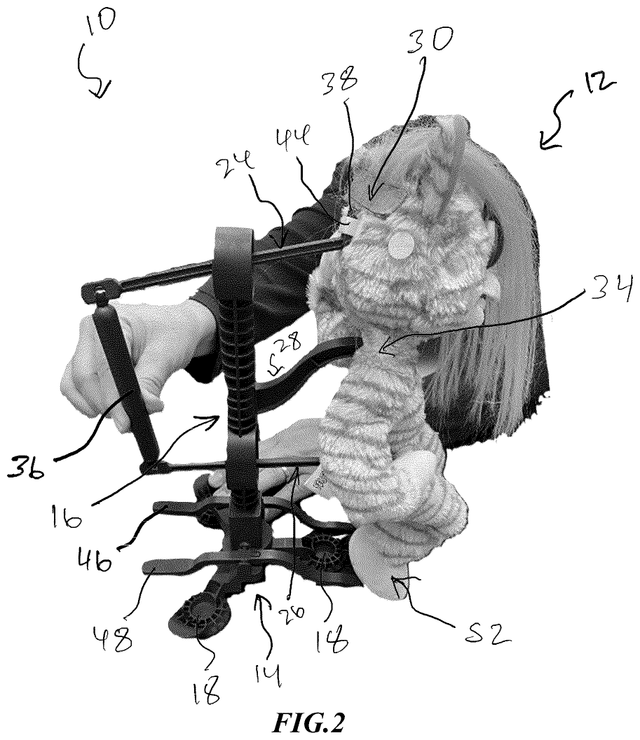

With particular reference to FIG. 2, the user maneuvers to linkage 36 to partially extend the first arm 24 though the first hole 20 and partially extend the second arm 26 through the second hole 22 to move the first part 30 (e.g. head) and the second part 32 (e.g. lower torso) of

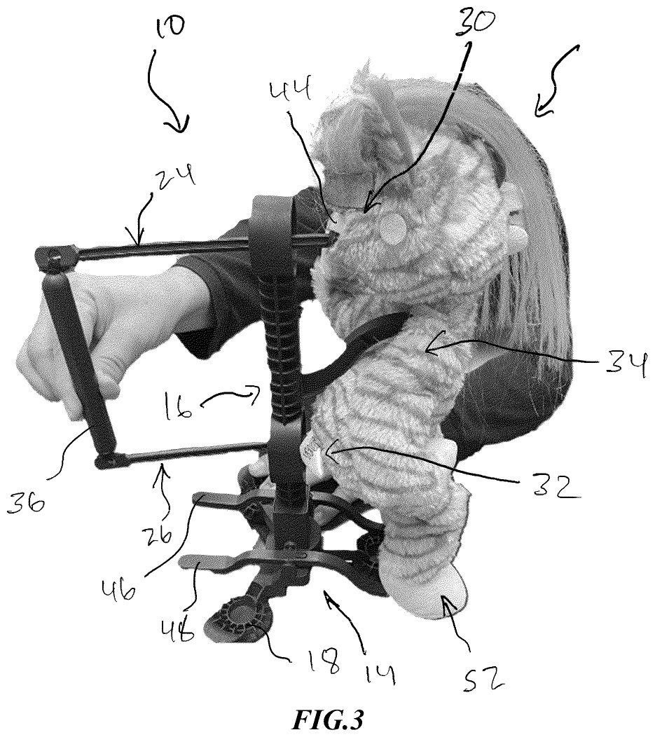

the object 12 relative to the third part 34 (e.g. upper torso) of the object 12. With particular reference to FIG. 3, the user maneuvers to linkage 36 to retract the first arm 24 though the first hole 20 and retract the second arm 26 through the second hole 22 to move the first part 30 (e.g. head) and the second part 32 (e.g. lower torso) of the object 12 relative to the third part 34 (e.g. upper torso) of the object 12.

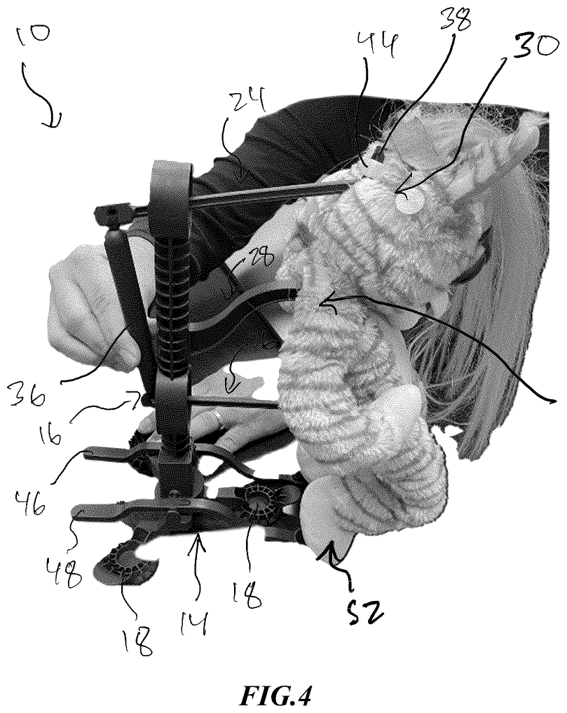

With particular reference to FIG. 4, the user maneuvers to linkage 36 to fully extend the first arm 24 though the first hole 20 and fully extend the second arm 26 through the second hole 22 to move the first part 30 (e.g. head) and the second part 32 (e.g. lower torso) of the object 12 relative to the third part 34 (e.g. upper torso) of the object 12.

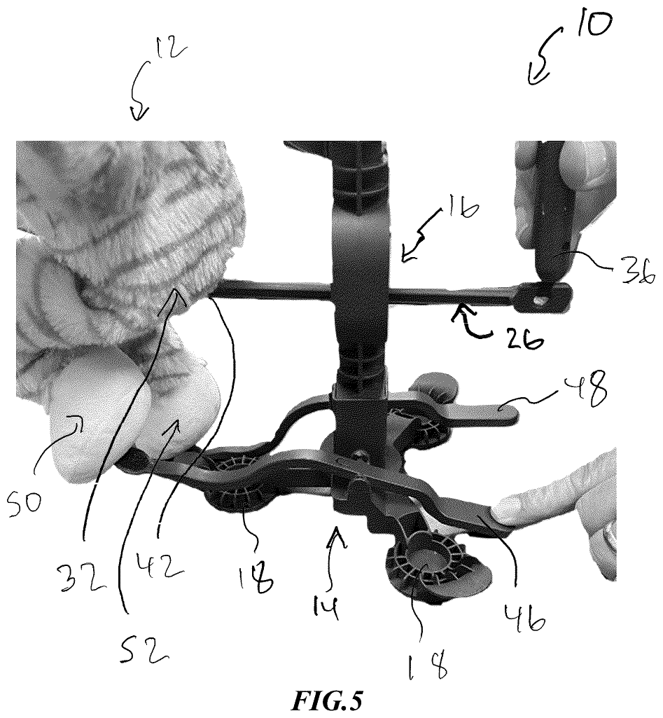

With particular reference to FIG. 5, the user maneuvers to linkage 36 to partially extend the second arm 26 though the second hole 22 and operates the first lever 46 to pivot the first lever 46 upward to move the second part 32 (e.g. lower torso) and the fourth part 50 (e.g. left foot) of the object 12 relative to the third part 34 (e.g. upper torso) of the object 12.

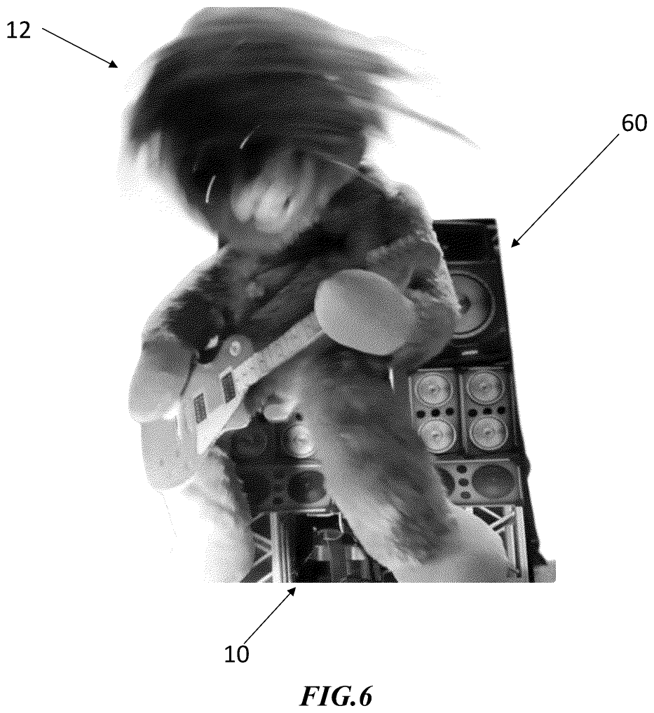

With particular reference to FIG. 6, the animation device 10 may be implemented with a structure 60 such that the animation device 10 may be positioned at least partially behind the structure 60, typically where the support member 16 and/or the base 12 are positioned behind the structure 60 relative to the object 12 positioned in front of the structure 60. The user would typically maneuver the linkage 36 from behind the structure 60 so that both the user and the majority of the animation device 10 are concealed behind the structure 60 while the object 12 is positioned in front of the structure.

It is further contemplated that, to manipulate the fourth part 50, the animation device 10 may further comprise a fourth arm. Such fourth arm may be moveably coupled to the support member 16 and may be manipulated by the user when the user maneuvers to linkage 26 to extend or pivot the fourth part 50. As will be readily appreciated, any number of parts on the object may be coupled to the support member via any number of arms, and any individual arm may be configured to manipulate one or multiple parts.

In further embodiments, it is noted that where the object is a puppet, the puppet may, in some embodiments, have long hair that will move relative to the head when the puppet is manipulated. In addition, it is contemplated that the puppet may also include a mechanism that allows the puppet to change one or more facial expression, and/or to move one or both arms coordinately or independently.

The animation device 10 may be formed of any material or combination of materials known in the art so long as the material or combination of materials are suitable for manipulating the object 12. Non-limiting examples include polymeric materials, lignocellulosic materials, cementitious materials, metal-containing materials, fibrous materials, or combinations thereof. In various embodiments, the base 14, the support member 16, the first arm 24, the second arm 26, the third arm 28, the first lever 46, and the second lever 48 are formed from a polymeric material. It is further contemplated that the animation device 10 may comprise one or more pivot points, wherein a pivot point describes any point where two parts meet and can move relative to each other. It is contemplated that pivot points may be configured as low-friction interfaces. For example, a pivot point may comprise polymer bushings with embedded lubricants to reduce friction and wear after use. Alternatively, or in addition, the pivot point may comprise Nylon, PTFE (Teflon®), polyethylene, acetal, or other polymer bushing materials. The pivot point may additionally or alternatively comprise rubber, EPDM rubber, styrene butadiene rubber, natural rubber, silicone rubber, butyl rubber, polychloroprene, and/or other unsaturated and/or saturated elastomers. The pivot point may be coated with a friction-mitigating substance.

To this end, these components of the animation device 10 may be formed using additive manufacturing. However, it is to be appreciated that other forms of manufacturing may be utilized (e.g. casting, extrusion, etc.). Further, it is contemplated that the animation device may be not only be operated by hand, but that one or more mechanical operators (e.g., electric motor, electromagnets, etc.) can likewise be utilized for operation. Where the animation device 10 is operated by hand, it is contemplated that the animation device 10 and/or the object may be manipulated by hand from a distance, eliminating the need for a user's hand to be in close contact with the animation device 10 and/or object 12.

It is further contemplated that the animation device 10 disclosed herein may, in some embodiments, be disposed behind a structure 60 so as to be substantially concealed from a viewer's line of sight, especially where the viewer's line of sight is facing a face of a puppet coupled to the animation device 10. Therefore, the animation device 10 may be positioned at least partially behind a structure 60, typically where the support member 16 and/or the base 12 are positioned behind the structure 60 relative to the object 12 positioned in front of the structure 60. Preferably, the structure 60 may include one or more passages configured to allow the first arm 24, the second arm 26, and the third arm 28 to extend through the structure 60, preferably wherein the passages preserve the ability of the arms to move, pivot, slide, rotate, etc., without substantial restriction. Typically, the support member 16 and/or the base 12 are disposed behind the structure 60 while the arms extend through the passages of the structure 60, providing a display of the object 12 in front of the structure 60. It is contemplated that, especially where the animation device 10 is used for a performance and/or display of the object 12, the structure 60 may be designed to blend with thematic elements of the performance and/or display. For example, if the object 12 appears as a rockstar holding a guitar, the structure 60 may be designed as relatively large stereo speakers, simultaneously concealing the animation device 10 and contributing to the visual elements of the performance and/or display.

In turn, it is contemplated that the support member 16, the linkage 36, and/or the base 14 may be positioned at varying distances from the object 12, especially the first arm 24, the second arm 26, the third arm 28, the first lever 46, and/or the second lever 48 vary in length. For example, in embodiments where it is desired that the user is further from the object 12, such as to further conceal the animation device 10 from a viewer, the support member 16, the linkage 36, and/or the base 14 may be positioned more than 10 cm, 15 cm, 20 cm, 25 cm, 30 cm, 50 cm, and/or 75 cm from the object 12. However, in embodiments where it is desired that the user is closer to the object 12, such as to maximize real-time control of the object 12, the support member 16, the linkage 36, and/or the base 14 may be positioned less than 20 cm, 15 cm, 10 cm, 9 cm, 8 cm, 7 cm, 6 cm, 5 cm, 4, cm, 3 cm, or 2 cm away from the object. It should be readily appreciated that the lengths of the first arm 24, the second arm 26, the third arm 28, the first lever 46, and/or the second lever 48 may increase or decrease depending on the distance of the support member 16 from the object 12. It is further contemplated that any of these components may be adjustable in length. The adjustability of a component's length or of the distance between two components may be enabled via a screw, chain, sprocket, pinion, rack and gear, and/or other adjustable length mechanism. Such adjustable length mechanism may further comprise a locking or tensioning device, such as a clamp, locknut, collar, or other device.

The inventors also contemplate that, in some embodiments, the object 12 may comprise a light source. For example, if the object is a puppet, the puppet may have glowing eyes, a glowing object, or another housing for a light source. The light source may be configured to blink or strobe, especially in coordination with music. In another embodiment, the object or the animation device further comprises an audio source, such as a speaker. The light source and/or the audio source may be communicatively coupled to a controller such that the controller may issue commands to the light source and/or the audio source. The controller may be a remote controller, such as a handheld remote, smartphone app, and/or Bluetooth® device, or may be non-remote, such as a switch, button, or screen disposed on or coupled to the animation device. The controller may, for example, enable a user to select music or other audio to play from the audio source. The controller may additionally enable a user to select a light show to play from the light source which may or may not be in coordination with the selected music or other audio. The controller may enable a user to change the color, brightness, intensity, rate of strobing, or other parameters of the light emitted from the light source. Similarly, the controller may enable the user to adjust the volume, pitch, or audio effects of the music or other audio played from the audio source. In addition, it is contemplated that a microphone may be communicatively coupled to the audio source, enabling a user to input audio through the microphone and cause the audio source to emit said audio. This is especially useful for performance-related uses of the animation device, as the puppet may appear to speak, sing, gesture, and/or dance.

It is noted that the instantly claimed invention provides several advantages over the prior art. For example, compared to the “omnidirectional toy manipulator” of Patent Publication No. US20060160466A1 discussed above, the instantly claimed invention is especially advantageous because of the ability for a user to independently manipulate different parts of a single object 12 relative to a fixed point of the object 12. For example, in the instant invention, it is contemplated that by operating the first arm 24 and the second arm 26, a first part 30 and a second part 32 of the object 12 may be manipulated relative to a third part 34 of the object 12 because the third part 34 is fixedly coupled to the support member 14 via the third arm 28. Both the first part 30 and the second part 32 may be manipulated in a synchronized manner by operating a linkage 36 coupled to both the first arm 24 and the second arm 26. However, the user may have the option of selectively manipulating one or the other. Such features of the instantly contemplated invention allow manipulation of the object 12 in any direction, which is clearly advantageous over the prior art which only supports vertical translation. Additionally, the fixing of the third part 34 of the object 12 to the support member 14 enables more direct control of the object 12 because the total number of uncontrolled degrees of freedom is reduced. This limitation of free movement channels the user's inputs into more predictable and measurable motions, allowing for finer adjustments and enhanced precision. This more controlled system ultimately facilitates better manipulation and consistency in the object's 12 behavior. Finally, it is contemplated that the setup and use of the animation device 10 is simplified compared to the prior art, which may require more components and a complex design.

Further, U.S. Pat. No. 4,179,843A, discussed above, does not provide the ability to manipulate a first and second part 30, 32 of a puppet relative to a third part 34 of the puppet. This is in part because the patent only describes two movable arms--one connected to the puppet's feet and one connected to the puppet's hands. There is no mention of a third, fixed arm 28 connected to another part of the puppet. The constraining mechanism in the patent is designed to either allow the two arms to move independently or to constrain them to move simultaneously. As a result, the complexity of the object/puppet's animation is limited. For instance, many natural movements involve parts of the body moving relative to a fixed point or axis, so the lack of this capability would make the object/puppet's movements appear less realistic or lifelike. Further, the object/puppet's range of motion and expressiveness would be limited without the ability to move two points relative to a third, fixed point. These shortcomings are solved by the features of the animation device 10 of the instant invention.

Still further, the disclosure in U.S. Pat. No. 6,575,808B1, discussed above, does not provide a mechanism for manipulating two distinct parts of the puppet relative to a fixed third point, as does the instant invention. Additionally, this known design requires a user to hold the device in his or her hands, thereby defeating one of several advantages of the device disclosed herein—namely, preserving the illusion that the object/puppet 12 moves independently of the user throughout the puppet's 12 performance. For example, at the end of the Detailed Description of the referenced patent, it is stated that “The puppet is held by a user's hand that grasps the handle. This same hand also operates the manipulable limb assemblies.” Therefore, as compared to this reference, the instant animation device 10 provides better control and more lifelike motion of the puppet by enabling manipulation of two parts 30, 32 of the object 12 relative to a fixed third part 34, and the instant animation device 10 need not be handheld, enabling a user to control the object 12 from behind a structure or from a distance, making the object 12 appear to move more independently of the user.

In the device disclosed in BE1016316A6, discussed above, because the different parts of the puppet/object must move in a synchronized manner, the realism of the puppet's movement is severely limited. The instant animation device 10, in contrast, provides the capability for distinct manipulation of different parts 30, 32 of the object 12 relative to a third part 34, enabling realistic movement in addition to better overall control of the object 12.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. An animation device for manipulating an object, the animation device comprising: a base;
a support member extending from the base;
a first arm moveably coupled to the support member and adapted to couple to a first part of the object;
a second arm moveably coupled to the support member and adapted to couple to a second part of the object; and
a third arm fixedly coupled to the support member and adapted to couple to a third part of the object;
wherein the first and second arms are adapted to be operated by a user for manipulating the first and second parts of the object relative to the third part of the object.

2. The animation device of claim 1, wherein the support member defines a first hole and a second hole spaced from the first hole, and the first arm engages the first hole and the second arm engages the second hole.

3. The animation device of claim 2, wherein the first arm extends through the first hole and the second arm extends through the second hole.

4. The animation device of claim 1 further comprising a linkage coupled to both the first arm and the second arm.

5. The animation device of claim 4, wherein the linkage is moveably coupled to both the first arm and the second arm.

6. The animation device of claim 1, wherein the first arm comprises a first arm hook adapted to couple to the first part of the object, the second arm comprises a second arm hook adapted to couple to the second part of the object, and the third arm comprises a third arm hook adapted to couple to the third part of the object.

7. The animation device of claim 1 further comprising a first lever moveably coupled to the base and adapted to couple to a fourth part of the object, wherein the first lever is adapted to be operated by the user for manipulating the fourth part of the object relative to the third part of the object.

8. The animation device of claim 7 further comprising a second lever moveably coupled to the base and adapted to couple to a fifth part of the object, wherein the second lever is adapted to be operated by the user for manipulating the fifth part of the object relative to the third part of the object.

9. The animation device of claim 8, wherein the first and second levers are pivotably coupled to base.

10. The animation device of claim 1, wherein the first arm, the second arm, and the third arm extend through a structure, wherein the support member and the object are disposed on opposite sides of the structure.

11. The animation device of claim 1, wherein the object is selected from the group of a stuffed animal, a doll, a puppet, and combinations thereof.

12. The animation device of claim 1, wherein the third arm is disposed between the first arm and second arm.

13. The animation device of claim 1, wherein the second arm is adjacent to the base and the first arm is spaced from the base.

14. The animation device of claim 1, wherein the base, the support member, the first arm, the second arm, the third arm, the first lever, and the second lever are formed from a polymeric material.

15. The animation device of claim 1, wherein the base, the support member, the first arm, the second arm, the third arm, the first lever, and the second lever are formed using additive manufacturing.

16. An animation device for manipulating a stuffed animal having a head, an upper torso, a lower torso, a left foot, and a right foot, the animation device comprising:
a base;
a support member extending from the base;
a first arm moveably coupled to the support member and coupled to the head;
a second arm moveably coupled to the support member and coupled to the lower torso;
a third arm fixedly coupled to the support member and coupled to the upper torso; a first lever movably coupled to the base and coupled to the left foot; and
a second lever movably coupled to the base and coupled to the right foot;
wherein the first and second arms, and first and second levers are adapted to be operated by a user for manipulating the head, the lower torso, left foot, and the right foot relative to the upper torso.

17. The animation device of claim 16, wherein the support member defines a first hole and a second hole spaced from the first hole, and the first arm engages the first hole and the second arm engages the second hole.

18. The animation device of claim 17, wherein the first arm extends through the first hole and the second arm extends through the second hole.

19. The animation device of claim 16 further comprising a linkage coupled to both the first arm and the second arm.

20. The animation device of claim 19, wherein the linkage is moveably coupled to both the first arm and the second arm.
